(19) United States
(12) Patent Application Publication
(10) Pub. No.: US 2026/0039049 A1
(43) Pub. Date: Feb. 5, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yasunori ASANO, Mie (JP)

(21) Appl. No.: 18/995,137

(22) PCT Filed: Jul. 7, 2023
(86) PCT No.: PCT/JP2023/025255

§ 371 Date: Jan. 16, 2025

(30) Foreign Application Priority Data
Jul. 25, 2022 (JP) 2022-117983

(51) Int. Cl. H01R 13/11; H01R 24/40

(52) U.S. Cl. CPC H01R 13/11; H01R 24/40

(57) ABSTRACT

A connector includes a connector conductor including a tube portion and a resilient piece extending from an opening edge of the tube portion. The tube portion includes a first circumferential end part, a tube forming portion forming a tube shape together with the first circumferential end part, a second circumferential end part connected to the tube forming portion on a side opposite to the first circumferential end part, the second circumferential end part being overlapped on the first circumferential end part, and a crimp portion for holding the first and second circumferential end parts in an overlapped state. At least a part of the resilient piece extends from the first circumferential end part.

### TECHNICAL FIELD

The present disclosure relates to a connector.

### BACKGROUND

Patent Document 1 discloses a coaxial connector provided with a contact, an insulator made of synthetic resin for holding the contact and a shell made of metal for accommodating the insulator. The shell made of metal includes a fitting portion formed into a substantially hollow cylindrical shape and to be fit to a mating male connector.

### PRIOR ART DOCUMENT

### Patent Document

Patent Document 1: JP 2003-297491 A

### SUMMARY OF THE INVENTION

### Problems to be Solved

Here, it is desired to manufacture a connector conductor including a tube portion with a low cost like the metal shell of the Patent Document and obtain a desired contact load in connecting this connector conductor to a mating member.

Accordingly, the present disclosure aims to manufacture a connector conductor with a low cost and obtain a desired contact load at the time of connection to a mating member.

### Means to Solve the Problem

The present disclosure is directed to a connector with a connector conductor including a tube portion and a resilient piece extending from an opening edge of the tube portion, the tube portion including a first circumferential end part, a tube forming portion forming a tube shape together with the first circumferential end part, a second circumferential end part connected to the tube forming portion on a side opposite to the first circumferential end part, the second circumferential end part being overlapped on the first circumferential end part, and a crimp portion for holding the first and second circumferential end parts in an overlapped state, and at least a part of the resilient piece extending from the first circumferential end part.

### Effect of the Invention

According to the present disclosure, a connector conductor can be manufactured with a low cost and a desired contact load can be obtained at the time of connection to a mating member.

### BRIEF DESCRIPTION OF THE DRAWINGS

FIG. 1 is a perspective view showing a device provided with a coaxial connector according to one embodiment.

FIG. 2 is a section along II-II of FIG. 1.

FIG. 3 is a perspective view showing the coaxial connector.

FIG. 4 is an exploded perspective view showing the coaxial connector.

FIG. 5 is a perspective view showing an outer conductor.

FIG. 6 is a bottom view showing the outer conductor.

FIG. 7 is a section along VII-VII of FIG. 6.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector is provided with a connector conductor including a tube portion and a resilient piece extending from an opening edge of the tube portion, the tube portion including a first circumferential end part, a tube forming portion forming a tube shape together with the first circumferential end part, a second circumferential end part connected to the tube forming portion on a side opposite to the first circumferential end part, the second circumferential end part being overlapped on the first circumferential end part, and a crimp portion for holding the first and second circumferential end parts in an overlapped state, and at least a part of the resilient piece extending from the first circumferential end part.

According to this connector, the tube portion includes the first circumferential end part, the tube forming portion forming a tube shape together with the first circumferential end part, the second circumferential end part connected to the tube forming portion on the side opposite to the first circumferential end part and overlapped on the first circumferential end part, and the crimp portion for holding the first and second circumferential end parts in the overlapped state. Thus, the connector conductor can be manufactured with a lower cost as compared to the case where the connector conductor is formed by cutting or welding a plate material. Further, since the first and second circumferential end parts are overlapped and at least a part of the resilient piece extends from the first circumferential end part, at least a part of a base end portion of the resilient piece is firmly held by an overlapping structure of the first and second circumferential end parts. In this way, a desired contact load is easily obtained when the connector conductor is connected to a mating member.

(2) In the connector of (1), half or more of a base end portion of the resilient piece in a width direction may be connected to the first circumferential end part.

In this way, half or more of the base end portion of the resilient piece in the width direction is connected to the first circumferential end part and supported by the overlapping structure of the first and second circumferential end parts. Thus, a desired contact load is easily obtained.

(3) In the connector of (1) or (2), the crimp portion may be separated from the resilient piece.

In this way, the deformation of the crimp portion hardly affects the resilient piece and a contact load of the resilient piece in design is easily ensured.

(4) In the connector of (3), a distance between the crimp portion and the resilient piece may be equal to or more than a distance between an edge of the tube portion on a side opposite to the resilient piece and the crimp portion.

In this way, the deformation of the crimp portion is less likely to affect the resilient piece and the contact load of the resilient piece in design is more easily ensured.

(5) In the connector of any one of (1) to (4), the resilient piece may include a contact point portion to be held in contact with a mating conductor, the contact point portion may be facing either one side in a radial direction of the tube portion, and the second circumferential end part may be overlapped on the first circumferential end part on a side opposite to the facing side of the contact point portion.

In this case, if the contact point portion contacts the mating conductor, a force in a direction opposite to a facing direction of the contact point portion acts on the resilient piece. This force can be received by the second circumferential end part. Thus, when the resilient piece is brought into contact with the mating conductor, the base end portion of the resilient piece is hardly displaced and a desired contact load is easily obtained.

(6) In the connector of (5), the contact point portion may be facing outward in the radial direction of the tube portion, the first circumferential end part and the tube forming portion may be connected into a tube shape having a constant diameter, and the second circumferential end part is overlapped inside the first circumferential end part and projects further toward an inner peripheral side than the tube forming portion.

In this way, the resilient piece can be effectively received when the connector conductor is connected to the mating conductor by insertion. Since the first circumferential end part and the tube forming portion are connected into the tube shape having a constant diameter, if another resilient piece extends from the tube forming portion, the resilient piece and the other resilient piece easily keep identical resilient properties. Further, by causing the second circumferential end part to project further toward the inner peripheral side than the tube forming portion, the second circumferential end part is easily positioned with respect to members in the tube portion.

(7) In the connector of any one of (1) to (6), the resilient piece may include a base end portion extending along an axial direction of the tube portion from a base end of the resilient piece and an inclined portion extending obliquely to the axial direction from a tip of the base end portion, and an edge of the second circumferential end part on a side where the resilient piece extends may be located between the base end of the resilient piece and a boundary between the base end portion and the inclined portion.

In this way, the base end portion of the resilient piece can be effectively received by the second circumferential end part.

(8) In the connector of any one of (1) to (7), the connector conductor may further include at least one additional resilient piece extending from the opening edge of the tube portion, and the resilient piece and the at least one additional resilient piece may be arranged and located at intervals in a circumferential direction of the tube portion.

In this way, the connector conductor can be satisfactorily electrically connected to the mating conductor.

(9) In the connector of (8), the resilient piece and the at least one additional resilient piece may be arranged and located at equal intervals in the circumferential direction of the tube portion.

In this way, contact loads of the resilient piece and the at least one additional resilient piece with the mating conductor can be made as equal as possible, and the connector conductor can be satisfactorily electrically connected to the mating conductor.

(10) The connector of any one of (1) to (9) may be further provided with an inner conductor and an insulator, the inner conductor being accommodated into the insulator, and the insulator may be accommodated in the tube portion.

In this case, the connector conductor can be satisfactorily electrically connected to the mating conductor in the connector provided with the inner conductor, the insulator, into which the inner conductor is accommodated, and the connector conductor as an outer conductor for accommodating the insulator.

(11) In the connector of (10), the insulator may include a recess on an outer peripheral side, and the second circumferential end part may be fit in the recess.

In this way, the connector conductor can be positioned with respect to the insulator, utilizing the second circumferential end part.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a connector according to an embodiment is described. In this embodiment, the connector is a coaxial connector. Note that the coaxial connector is a connector in which an outer conductor and an inner conductor inside the outer conductor are located on the same axis. It is not essential that the connector is the coaxial connector. For example, a plurality of inner conductors may be located in an outer conductor.

### <Concerning Overall Configuration of Device>

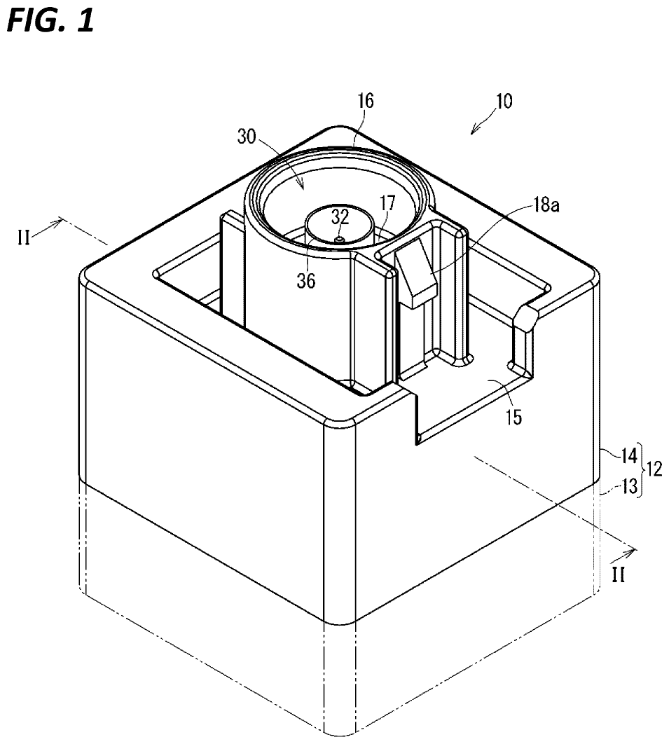

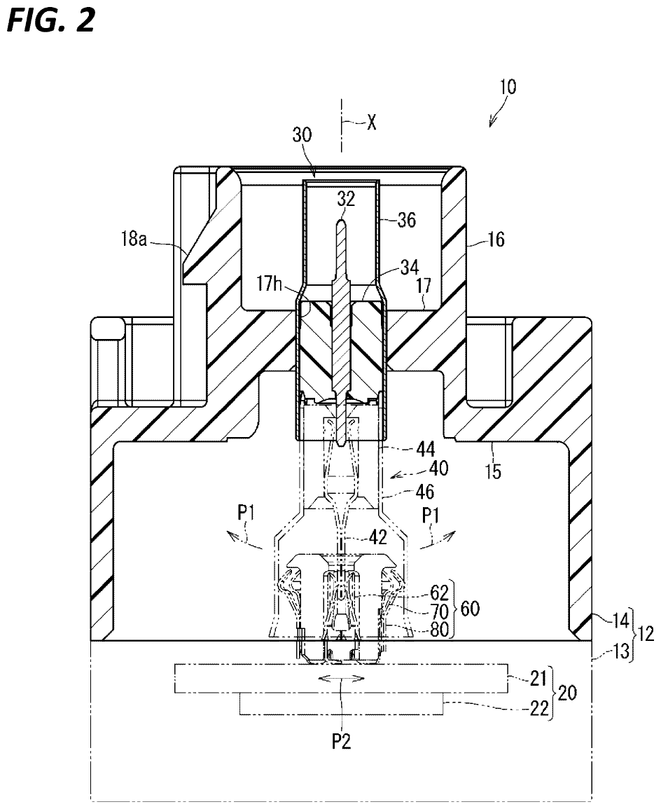

An example of a device 10 provided with a coaxial connector 60 is described. FIG. 1 is a perspective view showing the device 10 provided with the coaxial connector 60. FIG. 2 is a section along II-II of FIG. 1.

The device 10 is, for example, a camera device. The camera device is, for example, an in-vehicle device. The device 10 may not be a camera device.

The device 10 is provided with a case 12 and an electrical component 20. The electrical component 20 is accommodated in the case 12. The coaxial connector 60 is fixed to the electrical component 20.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes an external connection coaxial connector 30.

The external connection coaxial connector 30 is a coaxial connector for connecting the electrical component 20 and an external electrical component. For example, the external connection coaxial connector 30 is a coaxial connector, to which a cable connected to the external electrical component is connected. The cable connected to the external connection coaxial connector 30 is, for example, a coaxial cable.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16 (axial direction). In this embodiment, the holding/partitioning portion 17 is formed at a position near the inner opening in the intermediate part in the direction along the center axis X of the holding tube portion 16. The holding/partitioning portion 17 partitions between a space on the side of the inner opening and a space on the side of the outer opening in the holding tube portion 16. The holding/partitioning portion 17 is formed with a holding hole 17h, and the external connection coaxial connector 30 is inserted and held in the holding hole 17h.

In this embodiment, a locking protrusion 18a for holding a cable connector mounted on an end part of a cable is formed on an outer peripheral part of the holding tube portion 16. It is not essential that the locking protrusion 18a is formed.

The external connection coaxial connector 30 is provided with an external connection inner conductor 32, an external connection insulator 34 and an external connection outer conductor 36.

The external connection inner conductor 32 is in the form of an elongated bar and made of an electrically conductive material such as metal. The external connection insulator 34 is made of an insulating material such as resin and surrounds the external connection inner conductor 32. In this embodiment, the external connection insulator 34 is a dielectric. The external connection outer conductor 36 is made of an electrically conductive material such as metal. The external connection outer conductor 36 is formed into a tubular shape surrounding the external connection insulator 34.

The electrical component 20 is, for example, a mounting board, in which electronic components are mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

In this embodiment, the coaxial connector 60 is located on a surface of the circuit board 21 on a side opposite to the imaging element 22. The coaxial connector 60 is fixed to the circuit board 21 and projects from the circuit board 21 toward the external connection coaxial connector 30. The coaxial connector 60 is a board-side coaxial connector. The coaxial connector 60 is, for example, provided with an inner conductor 62, an insulator 70 and an outer conductor 80. A movable-side inner conductor 42 to be described later is connected to the inner conductor 62. The insulator 70 surrounds the inner conductor 62. The outer conductor 80 surrounds the insulator 70. That is, the inner conductor 62, the insulator 70 and the outer conductor 80 are concentrically arranged from a center toward an outer peripheral side in this order.

The coaxial connector 60 and the external connection coaxial connector 30 are connected via a relay connector 40. The relay connector 40 is, for example, provided with the movable-side inner conductor 42, a movable-side insulator 44 and a movable-side outer conductor 46. The movable-side insulator 44 surrounds the movable-side inner conductor 42. A dielectric can be grasped as one type of insulator, and the movable-side insulator 44 may be a dielectric. The movable-side outer conductor 46 surrounds the movable-side insulator 44. The movable-side inner conductor 42 is an example of a mating inner conductor to be connected to the inner conductor 62, the movable-side outer conductor 46 is an example of a mating outer conductor to be connected to the outer conductor 80, and the relay connector 40 is an example of a mating coaxial connector to be connected to the coaxial connector 60.

With the movable-side inner conductor 42 inserted and connected to the inner conductor 62 and the outer conductor 80 inserted and connected to the movable-side outer conductor 46, the relay connector 40 is connected to the coaxial connector 60. In this state, the relay connector 40 projects further toward the external connection coaxial connector 30 from the coaxial connector 60. By inserting and connecting the external connection inner conductor 32 to the movable-side inner conductor 42 and inserting and connecting the movable-side outer conductor 46 to the external connection outer conductor 36, the relay connector 40 is connected to the external connection coaxial connector 30. In this way, the relay connector 40 relays and connects the coaxial connector 60 and the external connection coaxial connector 30.

In this way, by connecting the external cable to the external connection coaxial connector 30, the external electrical component as a connection destination of this cable and the electrical component 20 in the case 12 are electrically connected.

In a connected state of the relay connector 40 and the coaxial connector 60, the movable-side inner conductor 42 is inserted and connected in an inclined state to the inner conductor 62. Further, the outer conductor 80 is inserted and connected in an inclined state to the movable-side outer conductor 46. That is, the relay connector 40 can be connected in an inclined state to the coaxial connector 60 (see an arrow P1 of FIG. 2). In this way, even if the coaxial connector 60 and the external connection coaxial connector 30 deviate from positions facing each other on the same axis (see an arrow P2 of FIG. 2) during an assembly operation or in a completed state of the device 10, the relay connector 40 is inclined with respect to the coaxial connector 60, thereby absorbing these positional deviations.

### <Concerning Coaxial Connector>

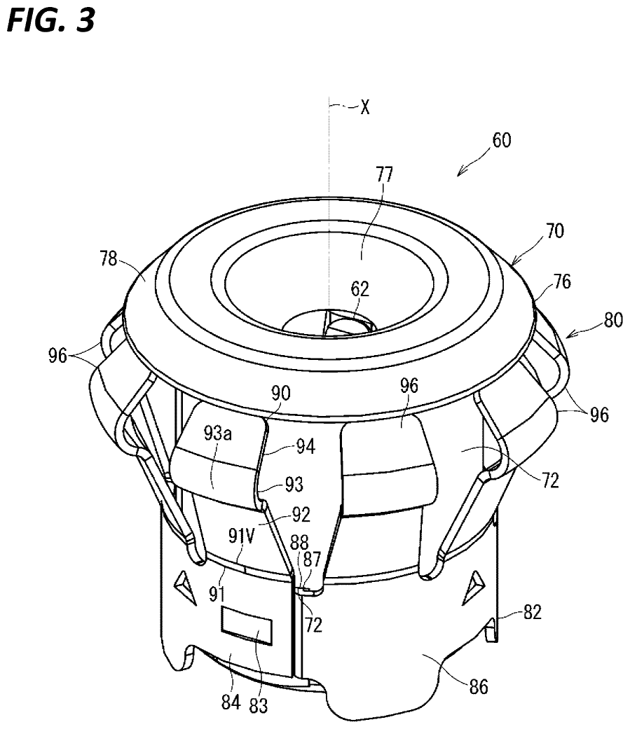

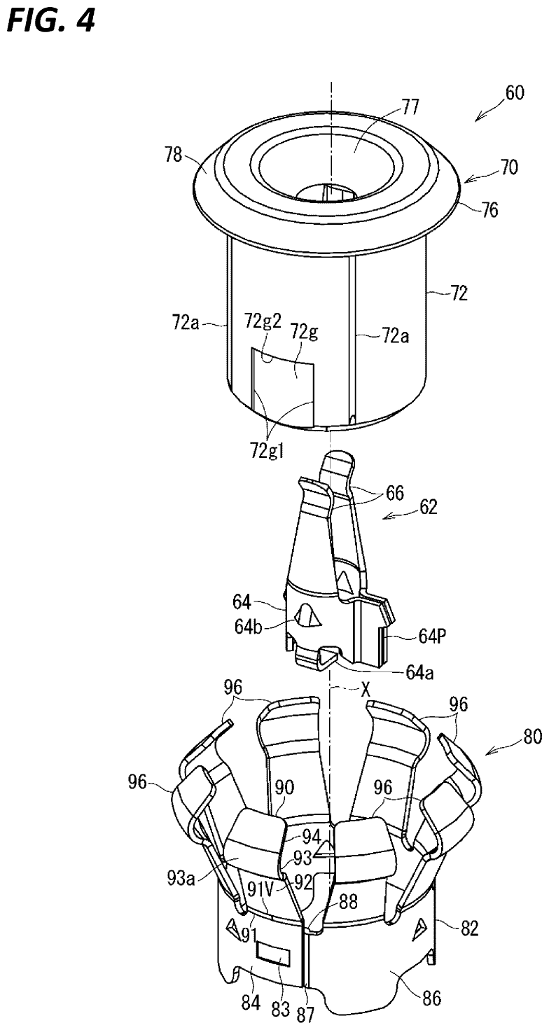

The coaxial connector 60 is specifically described. FIG. 3 is a perspective view showing the coaxial connector 60. FIG. 4 is an exploded perspective view showing the coaxial connector 60.

As described above, the coaxial connector 60 is, for example, provided with the inner conductor 62, the insulator 70 and the outer conductor 80.

The inner conductor 62 is an elongated electrically conductive member (see FIGS. 2 and 4). In this embodiment, the inner conductor 62 is formed by press-working a metal plate. More specifically, the inner conductor 62 includes a base end tube portion 64 and a plurality of resilient pieces 66.

The base end tube portion 64 is formed into a tubular shape, more specifically a hollow cylindrical shape. The base end tube portion 64 is accommodated on a base end side of the tube portion 72. Note that, in the coaxial connector 60, a tip is an end on a side to be connected to the movable-side inner conductor 42, and a base end is an end opposite to the tip, here, an end on a side facing the circuit board 21.

An extended piece 64a extends inwardly of the base end tube portion 64 from a base end side edge of the base end tube portion 64. The extended piece 64a may be soldered to a circuit of the circuit board 21.

The base end tube portion 64 may include a positioning protrusion 64P partially projecting toward an outer peripheral side in a circumferential direction. The inner conductor 62 may be positioned with respect to the insulator 70 by fitting this positioning protrusion 64P into a recess in the insulator 70.

Locking protrusions 64b project on the base end tube portion 64. The locking protrusion 64b partially projects from an outer peripheral part of the base end tube portion 64. The locking protrusion 64b is formed into a shape having a projecting dimension gradually increased from the tip toward the base end of the base end tube portion 64. With the base end tube portion 64 inserted in the insulator 70, the locking protrusions 64b are hooked to an inner peripheral part of the insulator 70 and the inner conductor 62 is retained and held in the insulator 70.

The plurality of resilient pieces 66 project further toward the tip side than a tip-side opening of the base end tube portion 64. Preferably, the plurality of resilient pieces 66 are located at equal intervals about a center axis X of the tube portion 72. In this embodiment, two resilient pieces 66 are facing each other around the center axis X of the base end tube portion 64.

The movable-side inner conductor 42 of the relay connector 40 is inserted into between the two resilient pieces 66 from the tip sides of the two resilient pieces 66. The movable-side inner conductor 42 is sandwiched by the two resilient pieces 66, thereby being connected to the inner conductor 62.

The insulator 70 is made of resin or the like. A dielectric can be grasped as one type of insulator, and the insulator 70 may be a dielectric. The insulator 70 is, for example, a molded resin component.

The insulator 70 is provided with the tube portion 72 and a tip guide portion 76.

The tube portion 72 is formed into a tube shape capable of accommodating the inner conductor 62. In this embodiment, the tube portion 72 is formed into a hollow cylindrical shape and a cylindrical space is formed inside. The inner conductor is accommodated in this cylindrical space.

The outer peripheral surface of the tube portion 72 is formed into a circumferential surface shape centered on the center axis X. The outer conductor 80 is arranged on an outer peripheral side of the tube portion 72. A positioning recess 72g is formed in a circumferential part of an outer peripheral part of the tube portion 72. The recess 72g includes a pair of side surfaces 72g1 facing each other in a circumferential direction of the tube portion 72 and a surface 72g2 facing a base end side of the tube portion 72 (see FIG. 4). A second circumferential end part 88 to be described later is fit into this recess 72g. In this state, the position of the second circumferential end part 88 is restricted by the pair of side surfaces 72g1 and the surface 72g2. In this way, the outer conductor 80 externally fit to the insulator 70 is restricted from rotating about the center axis X with respect to the insulator 70 and moving toward the tip side.

A plurality of (here, four) elongated protruding portions 72a are formed on the outer peripheral surface of the tube portion 72. Each protruding portion 72a extends in parallel to the center axis X. The plurality of protruding portions 72a are preferably located at equal intervals about the center axis X on the outer peripheral surface of the tube portion 72. The protruding portions 72a contact the inner peripheral surface of the tube portion 82 at positions distributed in the circumferential direction.

The tip guide portion 76 is located on the tip side of the tube portion 72. The tip guide portion 76 includes an insertion hole 77, into which the movable-side inner conductor 42 is insertable. The center axis X of the tube portion 72 coincides with a center axis X of the insertion hole 77.

The inner peripheral surface of the insertion hole 77 is formed into a tapered shape gradually reduced in diameter toward the inside of the tube portion 72. A tip part of the movable-side inner conductor 42 is guided toward between the plurality of resilient pieces 66 by the tapered inner peripheral surface of the insertion hole 77.

Further, an outer peripheral part of the tip guide portion 76 projects further toward the outer peripheral side than the tube portion 72. An outer peripheral side guide surface 78 gradually enlarged in diameter toward the base end side is formed on the outer peripheral part of the tip guide portion 76. The outer peripheral side guide surface 78 can function to guide a tubular part of the movable-side outer conductor 46 to the outside of the outer conductor 80.

The annular underside of the tip guide portion 76 facing the base end side extends orthogonally to the center axis X of the tube portion 72. A resilient piece 90 to be described later can be resiliently deformed in a radial direction of the tube portion 72 on a side closer to the base end than the annular underside.

The outer conductor 80 is made of an electrically conductive material such as metal and surrounds the insulator 70. The outer conductor 80 is, for example, formed, such as by press-working a metal plate.

The outer conductor 80 is provided with a tube portion 82 and the resilient piece 90. In this embodiment, the outer conductor 80 is further provided with additional resilient pieces 96.

The tube portion 82 is formed into a tube shape capable of arranging the tube portion 72 inside. The resilient piece 90 and the additional resilient pieces 96 extend from a tip side opening edge of the tube portion 82. The resilient piece 90 and the additional resilient pieces 96 are arranged to surround the tube portion 72 between the tip guide portion 76 and the tube portion 82.

The movable-side outer conductor 46 of the relay connector 40 is guided to an outer peripheral side of the resilient piece 90 and the additional resilient pieces 96 by the outer peripheral side guide surface 78 of the tip guide portion 76. In this way, the resilient piece 90 and the additional resilient pieces 96 contact the movable-side outer conductor 46 from an inner peripheral side and the outer conductor 80 and the movable-side outer conductor 46 are connected.

### <Concerning Outer Conductor>

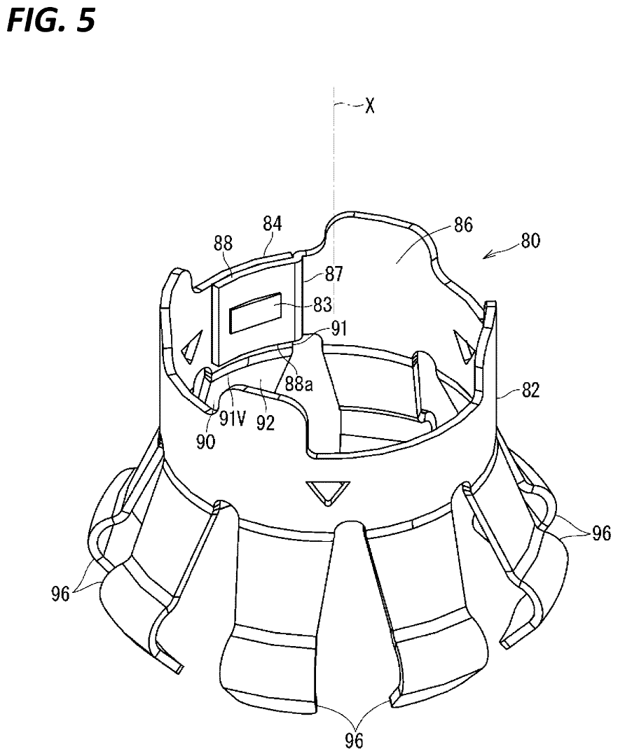

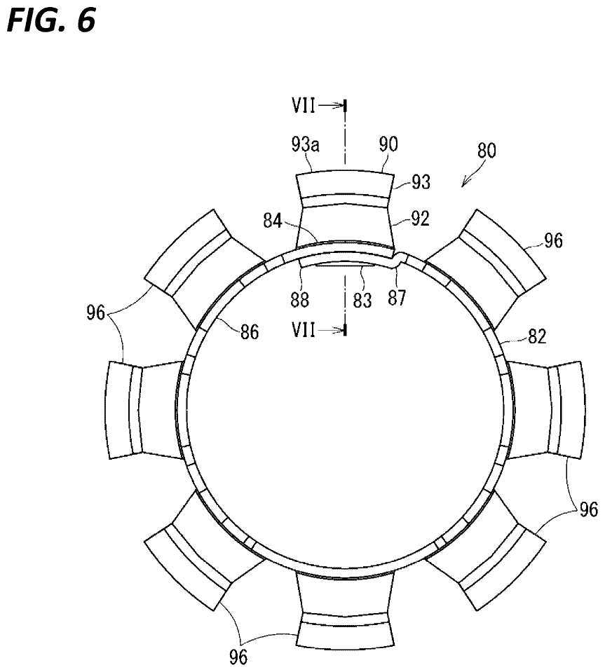

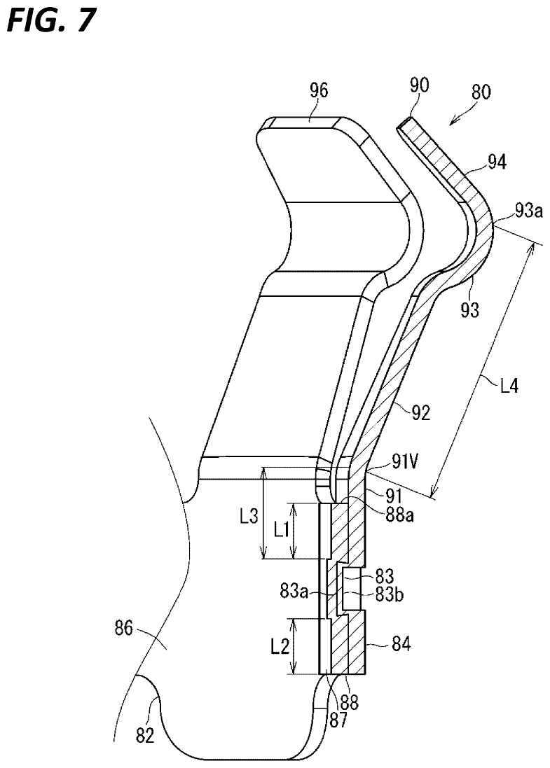

The outer conductor 80 as an example of a connector conductor is more specifically described. FIG. 5 is a perspective view showing the outer conductor 80. FIG. 6 is a bottom view showing the outer conductor 80. FIG. 7 is a section along VII-VII of FIG. 6.

As shown in FIGS. 3 to 7, the outer conductor 80 is provided with the tube portion 82 and the resilient piece 90 extending from the tip side opening edge of the tube portion 82.

The tube portion 82 is a part to be externally fit to the insulator 70. The tube portion 82 is held at a fixed position with respect to the insulator 70 and functions to support the outer conductor 80 at a fixed position with respect to the insulator 70. Further, if a base end side opening of the tube portion 82 is, for example, soldered to the circuit of the circuit board 21, e.g. a ground circuit, the tube portion 82 can function to ground the movable-side outer conductor 46 to the ground circuit.

The tube portion 82 includes a first circumferential end part 84, a tube forming portion 86 and the second circumferential end part 88.

The tube forming portion 86 has a partial tube shape. The first circumferential end part 84 is connected to one end side in a circumferential direction of the tube forming portion 86. The tube forming portion 86 forms a tube shape together with the first circumferential end part 84. More specifically, the first circumferential end part 84 and the tube forming portion 86 form a tube shape over an entire circumference.

The second circumferential end part 88 is connected to a side of the tube forming portion 86 opposite to the first circumferential end part 84. The second circumferential end part 88 is overlapped on the first circumferential end part 84. That is, the first circumferential end part 84, the tube forming portion 86 and the second circumferential end part 88 are shaped to exceed the tube shape over the entire circumference, and both end parts of the tube portion 82 are overlapped by a dimension exceeding the entire circumference. One of the overlapped parts is the first circumferential end part 84 and the other is the second circumferential end part 88.

The second circumferential end part 88 may be overlapped on an inner peripheral side of the first circumferential end part 84 or may be overlapped on an outer peripheral side thereof. The second circumferential end part 88 is preferably overlapped on the first circumferential end part 84 on a side opposite to a facing side of a contact point portion 93a. In this embodiment, the contact point portion 93a is facing an outer peripheral side as described later. Thus, the second circumferential end part 88 is overlapped on the inner peripheral side of the first circumferential end part 84.

If a resilient piece contacts a mating conductor from an outer peripheral side, contrary to the above case, i.e. if a contact point portion is facing an inner peripheral side, a second circumferential end part is preferably overlapped on an outer peripheral side of a first circumferential end part.

In this embodiment, the first circumferential end part 84 and the tube forming portion 86 are connected into a tube shape having a constant diameter. That is, the first circumferential end part 84 and the tube forming portion 86 are shaped to have the same radius of curvature. The second circumferential end part 88 is overlapped inside the first circumferential end part 84 and projects further toward the inner peripheral side than the tube forming portion 86. More specifically, a step portion 87 is formed between the tube forming portion 86 and the second circumferential end part 88. A step of the step portion 87 is, for example, set to be about a thickness of the tube portion 82. The second circumferential end part 88 projects further inward than the tube forming portion 86 via this step portion 87. The second circumferential end part 88 projects inward from the first circumferential end part 84 and the tube forming portion 86 by the thickness of the tube portion 82.

With the tube portion 72 of the insulator 70 accommodated in the tube portion 82, the second circumferential end part 88 is fit in the positioning recess 72g of the tube portion 72. In this state, the second circumferential end part 88 contacts the pair of side surfaces 72g1 of the recess 72g, thereby stopping the rotation of the outer conductor 80 with respect to the insulator 70. By the contact of the second circumferential end part 88 with the surface 72g2 of the recess 72g, the erroneous insertion of the tube portion 72 of the insulator 70 into the tube portion 82 of the outer conductor 80 is suppressed.

The tube portion 82 further includes a crimp portion 83. The crimp portion 83 is a part for holding the first and second circumferential end parts 84, 88 in the overlapped state. The crimp portion 83 holds the first and second circumferential end parts 84, 88 in the overlapped state by the plastic deformation of at least one of the first and second circumferential end parts 84, 88.

In this embodiment, one of the first and second circumferential end parts 84, 88 is formed with a protrusion 83a by plastic deformation, and the other is formed with a recess 83b by plastic deformation. By fitting the protrusion 83a into the recess 83b, the first and second circumferential end parts 84, 88 are held in the overlapped state.

More specifically, the overlapped first and second circumferential end parts 84, 88 are, for example, sandwiched and pressed between a press mold including a protrusion and a press mold including a recess. Then, parts of the first and second circumferential end parts 84, 88 are extruded and pressed each other from the protrusion of the press mold toward the recess of the press mold. The first and second circumferential end parts 84, 88 are simultaneously formed with the protrusion 83a and the recess 83b fitting each other by press working.

Such a fitting structure may be, for example, a structure called a spot crimp or a structure called a draw lock.

The resilient piece 90 is a part extending from an opening edge on one side of the tube portion 82 and to be connected to the movable-side outer conductor 46 as a mating terminal. At least a part of the resilient piece 90 extends from the first circumferential end part 84, out of the opening edge on the one side of the tube portion 82.

That is, the first circumferential end part 84 and the tube forming portion 86 form the tube shape over the entire circumference, and at least a part of the resilient piece 90 extends from the first circumferential end part 84.

At least a part of a base end part of the resilient piece 90 may be connected to the first circumferential end part 84. To more firmly support the resilient piece 90, half or more of the base end part of the resilient piece 90 in a width direction is preferably connected to the first circumferential end part 84. More preferably, ¾ or more of the base end part of the resilient piece 90 in the width direction is connected to the first circumferential end part 84. In this embodiment, the entire base end part in the width direction of the resilient piece 90 is connected to the first circumferential end part 84.

The resilient piece 90 includes a base end portion 91, an inclined portion 92, a bulging portion 93 and a tip guide portion 94. The base end portion 91, the inclined portion 92, the bulging portion 93 and the tip guide portion 94 are connected in this order from the tube portion 82 toward one side of a center axis X of the tube portion 82.

The base end portion 91 is a plate-like part directly connected to the first circumferential end part 84 and separated from adjacent additional resilient pieces 96. The inclined portion 92 is a plate-like part directly connected to the base end portion 91 and further extending from the base end portion 91.

The base end portion 91 extends along the center axis X of the tube portion 82 from the base end of the resilient piece 90 connected to the first circumferential end part 84. The inclined portion 92 extends obliquely (here, oblique toward the outer peripheral side) to the center axis X from the tip of the base end portion 91. Thus, the resilient piece 90 includes a bent part 91V between the base end portion 91 and the inclined portion 92. The resilient piece 90 can be resiliently deformed outwardly and inwardly of the tube portion 82 mainly from the bent part 91V to a tip-side part.

The bulging portion 93 extends from the tip of the inclined portion 92 toward the one side of the center axis X while forming a curved surface convex outward. Out of the bulging portion 93, a part projecting most toward the outer peripheral side is the contact point portion 93a facing outward in a radial direction of the tube portion 82 and configured to contact the movable-side outer conductor 46.

The tip guide portion 76 is inclined radially inward toward the one side of the center axis X from the tip of the bulging portion 93.

When the outer conductor 80 is inserted into the movable-side outer conductor 46, the tip guide portion 76 contacts the opening edge of the movable-side outer conductor 46, whereby the resilient piece 90 is guided to the inner peripheral side of the movable-side outer conductor 46. With the outer conductor 80 inserted in the movable-side outer conductor 46, the inclined portion 92 is mainly resiliently deformed to the inner peripheral side. The contact point portion 93a is resiliently pressed against the inner peripheral surface of the movable-side outer conductor 46 by a resilient force of the inclined portion 92 trying to return to an initial shape.

A set example of a preferable positional relationship of the second circumferential end part 88 and the crimp portion 83 with respect to the resilient piece 90 is described.

The crimp portion 83 is preferably located away from the resilient piece 90. In deforming the first and second circumferential end parts 84, 88, there is a possibility that deformation affects the periphery of the crimp portion 83. If the resilient piece 90 and a part supporting the resilient piece 90 are deformed in an unintended manner, this possibly affects the resilient deformation of the resilient piece 90 with the outer conductor 80 inserted in the movable-side outer conductor 46. If the crimp portion 83 is separated from the resilient piece 90, the deformation of the crimp portion 83 hardly affects the resilient piece 90 and the part supporting the resilient piece 90. In this way, the resilient piece 90 is pressed against the movable-side outer conductor 46 with a resilient force preferable in design.

For example, a distance L1 between the crimp portion 83 and the base end of the resilient piece 90 may be equal to or more than a distance L2 between an edge of the tube portion 82 on a side opposite to the resilient piece 90 and the crimp portion 83. Further, if L3, L4 denote, for example, a distance between the bent part 91V between the base end portion 91 and the inclined portion 92 of the resilient piece 90 and the crimp portion 83 and a distance between the bent part 91V and the contact point portion 93a, L3 may be equal to or more than ⅓ of L4 or equal to or less than ½ of L4.

Further, an edge 88a of the second circumferential end part 88 on a side where the resilient piece 90 extends is preferably located between the base end of the resilient piece 90 (i.e. a boundary between the resilient piece 90 and the second circumferential end part 88) and the bent part 91V, which is a boundary between the base end portion 91 and the inclined portion 92.

If the edge 88a of the second circumferential end part 88 on the side where the resilient piece 90 extends is too distant from the resilient piece 90, the resilient piece 90 cannot be effectively supported from the inner peripheral side. If this edge 88a coincides with the base end of the resilient piece 90 or exceeds this base end, the second circumferential end part 88 can effectively support the resilient piece 90 from the inner peripheral side.

If the edge 88a of the second circumferential end part 88 on the side where the resilient piece 90 extends too long, there is a wasteful region. If the edge 88a is located at or before the bent part 91V, the second circumferential end part 88 can be arranged in a region effective to support the resilient piece 90.

As described above, the outer conductor 80 further includes at least one additional resilient piece 96 extending from the opening edge of the tube portion 82. In this embodiment, the outer conductor 80 includes a plurality of the additional resilient pieces 96, specifically seven additional resilient pieces 96. That is, the outer conductor 80 includes a plurality of resilient pieces 90, 96, more specifically eight resilient pieces 90, 96.

The additional resilient piece 96 is shaped similarly to the resilient piece 90 except a part supported on the tube portion 82.

The plurality of resilient pieces 90, 96 are supported at equal intervals in the circumferential direction of the tube portion 82. Note that equal intervals are equal within an error range (e.g. equal within a range of ±5° about the center axis X). When viewed along the center axis X of the tube portion 82, the plurality of resilient pieces 90, 96 are radially arranged with the center axis X of the tube portion 82 as a center.

With the outer conductor 80 inserted in the movable-side outer conductor 46, the plurality of resilient pieces 90, 96 are in contact with an inner peripheral part of the movable-side outer conductor 46 at equal intervals along the circumferential direction. Since the plurality of resilient pieces 90, 96 have the same shape and are arranged at equal intervals along the circumferential direction of the tube portion 82, the plurality of resilient pieces 90, 96 are pressed against the movable-side outer conductor 46 under the same conditions. Further, if a plurality of resilient pieces are supported by a tube member including a cut, the tube member is resiliently deformable inward and outward near the cut. Thus, a force for supporting the resilient pieces becomes weaker and there is a possibility that a resilient force for pressing the resilient pieces against a mating conductor becomes weaker. Since the first circumferential end part 84 is supported by the second circumferential end part 88 in this embodiment, the base end of the resilient piece 90 is easily supported at a fixed position, wherefore the resilient piece 90 is easily held pressed against the movable-side outer conductor 46 with a desired contact load in design.

### Effects, Etc.

According to the coaxial connector 60 configured as described above, the first and second circumferential end parts 84, 88 of the tube portion 82 are held in the overlapped state by the crimp portion 83. Thus, the outer conductor 80 can be easily formed by press-working a metal plate material. In this way, the outer conductor 80 can be manufactured with a lower cost as compared to the case where the outer conductor 80 is formed by cutting or welding a plate material. Further, since the first and second circumferential end parts 84, 88 are overlapped and at least a part of the resilient piece 90 extends from the first circumferential end part 84, at least a part of the base end portion 91 of the resilient piece 90 is firmly held by the overlapping structure of the first and second circumferential end parts 84, 88. In this way, a desired contact load is easily obtained when the outer conductor 80 is connected to the movable-side outer conductor 46, which is a mating member.

Further, if half or more of the base end portion 91 of the resilient piece 90 in the width direction is connected to the first circumferential end part 84, the resilient piece 90 can be firmly supported by the overlapping structure of the first and second circumferential end parts 84, 88 and a desired contact load is easily obtained.

Further, if the crimp portion 83 is separated from the resilient piece 90, the deformation of the crimp portion 83 hardly affects the resilient piece 90 and the part supporting the resilient piece 90. In this way, a contact load of the resilient piece 90 in design is easily ensured.

Particularly, by setting the distance L1 between the crimp portion 83 and the resilient piece 90 equal to or more than the distance L2 between the edge of the tube portion 82 on the side opposite to the resilient piece 90 and the crimp portion 83, the deformation of the crimp portion 83 is less likely to affect the resilient piece 90. In this way, a contact load of the resilient piece 90 in design is more easily ensured.

Further, the second circumferential end part 88 is overlapped on the first circumferential end part 84 on the side opposite to the facing side of the contact point portion 93a. If the contact point portion 93a contacts the movable-side outer conductor 46, a force acting in a direction opposite to a facing direction of the contact point portion 93a acts on the resilient piece 90. This force can be effectively received by the second circumferential end part 88. Thus, when the resilient piece 90 is brought into contact with the movable-side outer conductor 46, the base end portion of the resilient piece 90 is hardly displaced and a desired contact load is easily obtained.

Further, since the first circumferential end part 84 and the tube forming portion 86 are connected into the tube shape having a constant diameter, resilient properties of the resilient piece 90 and the other additional resilient pieces 96 are easily kept identical when the other additional resilient pieces 96 extend from the tube forming portion 86. Further, by causing the second circumferential end part 88 to project further toward the inner peripheral side than the tube forming portion 86, the second circumferential end part 88 is easily positioned with respect to members in the tube portion.

In this embodiment, the outer conductor 80 is positioned with respect to the one axial side of the insulator 70 and in the circumferential direction, utilizing the second circumferential end part 88, by fitting the second circumferential end part 88 into the recess 72g of the insulator 70.

Further, since the edge 88a of the second circumferential end part 88 on the side where the resilient piece 90 extends is located between the base end of the resilient piece 90 and the bent part 91V on the boundary between the base end portion 91 and the inclined portion 92, the base end portion of the resilient piece 90 can be effectively received without excessively extending the second circumferential end part 88.

Further, the outer conductor 80 further includes at least one additional resilient piece 96 extending from the opening edge of the tube portion 82, and the resilient piece 90 and the at least one additional resilient piece 96 are arranged and located at intervals in the circumferential direction of the tube portion 82. Thus, the outer conductor 80 can be satisfactorily electrically connected to the movable-side outer conductor 46. The resilient piece 90 located on a joint of the tube portion 82 is also satisfactorily electrically connected to the movable-side outer conductor 46.

Further, since the resilient piece 90 and the at least one additional resilient piece 96 are arranged at equal intervals in the circumferential direction of the tube portion 82, contact loads of the plurality of resilient pieces 90, 96 can be made as equal as possible. In this way, the outer conductor 80 can be satisfactorily electrically connected to the movable-side outer conductor 46.

The coaxial connector 60 is further provided with the inner conductor 62 and the insulator 70, and the outer conductor 80 for accommodating the insulator 70 can be satisfactorily electrically connected to the movable-side outer conductor 46.

### Modifications

In the above embodiment, a configuration relating to the tube portion 82 of the outer conductor 80 may be applied to a tube portion of another connector conductor. For example, a configuration relating to the tube portion 82 for overlapping and joining first and second circumferential end parts by a crimp portion may be applied to the base end tube portion 64 of the inner conductor 62 in the above embodiment.

Note that the above embodiment and the respective configurations described in the respective modifications can be appropriately combined without technically contradicting each other.

### LIST OF REFERENCE NUMERALS

10 device
12 case
13 first case
14 second case
bottom part
16 holding tube portion
17 holding/partitioning portion
17h holding hole
18a locking protrusion
20 electrical component
21 circuit board
22 imaging element
25 external connection coaxial connector
32 external connection inner conductor
34 external connection insulator
36 external connection outer conductor
40 relay connector
42 movable-side inner conductor
44 movable-side insulator
46 movable-side outer conductor (mating outer conductor)
60 coaxial connector (connector)
62 inner conductor
64 base end tube portion
64P positioning protrusion
64a extended piece
64b locking protrusion
66 resilient piece
70 insulator
72 tube portion
72a protruding portion
72g recess
72g1 side surface
72g2 surface
76 tip guide portion
77 insertion hole
78 outer peripheral side guide surface
80 outer conductor (connector conductor)
82 tube portion
83 crimp portion
83a protrusion
83b recess
84 first circumferential end part
86 tube forming portion
87 step portion
88 second circumferential end part
88a edge
90 resilient piece
91 base end portion
91V bent part
92 inclined portion
93 bulging portion
93a contact point portion
94 tip guide portion
96 additional resilient piece
X center axis

1. A connector, comprising a connector conductor including a tube portion and a resilient piece extending from an opening edge of the tube portion,
the tube portion including:
a first circumferential end part;
a tube forming portion forming a tube shape together with the first circumferential end part;
a second circumferential end part connected to the tube forming portion on a side opposite to the first circumferential end part, the second circumferential end part being overlapped on the first circumferential end part; and
a crimp portion for holding the first and second circumferential end parts in an overlapped state, and
at least a part of the resilient piece extending from the first circumferential end part.

2. The connector of claim 1, wherein half or more of a base end portion of the resilient piece in a width direction is connected to the first circumferential end part.

3. The connector of claim 1, wherein the crimp portion is separated from the resilient piece.

4. The connector of claim 3, wherein a distance between the crimp portion and the resilient piece is equal to or more than a distance between an edge of the tube portion on a side opposite to the resilient piece and the crimp portion.

5. The connector of claim 1, wherein:
the resilient piece includes a contact point portion to be held in contact with a mating conductor,
the contact point portion is facing either one side in a radial direction of the tube portion, and
the second circumferential end part is overlapped on the first circumferential end part on a side opposite to the facing side of the contact point portion.

6. The connector of claim 5, wherein:
the contact point portion is facing outward in the radial direction of the tube portion,
the first circumferential end part and the tube forming portion are connected into a tube shape having a constant diameter, and
the second circumferential end part is overlapped inside the first circumferential end part and projects further toward an inner peripheral side than the tube forming portion.

7. The connector of claim 1, wherein:
the resilient piece includes a base end portion extending along an axial direction of the tube portion from a base end of the resilient piece and an inclined portion extending obliquely to the axial direction from a tip of the base end portion, and
an edge of the second circumferential end part on a side where the resilient piece extends is located between the base end of the resilient piece and a boundary between the base end portion and the inclined portion.

8. The connector of claim 1, wherein:
the connector conductor further includes at least one additional resilient piece extending from the opening edge of the tube portion, and
the resilient piece and the at least one additional resilient piece are arranged and located at intervals in a circumferential direction of the tube portion.

9. The connector of claim 8, wherein the resilient piece and the at least one additional resilient piece are arranged and located at equal intervals in the circumferential direction of the tube portion.

10. The connector of claim 1, further comprising an inner conductor and an insulator, the inner conductor being accommodated into the insulator, wherein:
the insulator is accommodated in the tube portion.

11. The connector of claim 10, wherein:
the insulator includes a recess on an outer peripheral side, and
the second circumferential end part is fit in the recess.
